(19) United States
(12) Patent Application Publication
(10) Pub. No.: US 2024/0334044 A1
(43) Pub. Date: Oct. 3, 2024

(54) IMAGE PROCESSING APPARATUS, METHOD, AND STORAGE MEDIUM

(71) Applicant: CANON KABUSHIKI KAISHA, Tokyo (JP)

(72) Inventor: HIDEAKI OHSHIMA, Kanagawa (JP)

(21) Appl. No.: 18/615,392

(22) Filed: Mar. 25, 2024

(30) Foreign Application Priority Data
Mar. 27, 2023 (JP) 2023-050388

(51) Int. Cl. H04N 23/60

(52) U.S. Cl. CPC H04N 23/64

(57) ABSTRACT

An image processing apparatus includes at least one processor configured to perform processing on image data, determine whether or not the image data includes associated data that is data in association with the image data, and associate, when the image data includes the associated data, the associated data with image data after processing that is processed and generated in the processing.

### BACKGROUND

### Field of the Disclosure

The present disclosure relates to an image processing apparatus that processes images having associated data.

### Description of the Related Art

In recent years, there is an image capturing apparatus that can automatically or manually transmit captured image data to an external device via a network, owing to the improved network transmission speed. In addition, there is an image capturing apparatus in which a voice memo function used for business purposes is installed.

Audio data recorded as a voice memo is associated with image data. In addition, a function that allows the user to add information such as protection and rating to an image is provided, in order to improve the after-capture convenience. There is a workflow in which, in transmitting image data to an external device using a network, image processing is processed as necessary to narrow down the images by filtering based on additional information of the images, and the images thus narrowed down are transmitted with associated audio data.

For example, in Japanese Patent Laid-Open No. 2007-180779, a data transmission apparatus is disclosed, which, in transmitting audio data to another electronic apparatus, extracts image data, associates the audio data with the image data, and transmits the associated image data with the audio data to a playback apparatus.

However, in the conventional technology disclosed in Japanese Patent Laid-Open No. 2007-180779 described above, it is not taken into account of a case where association between the audio data and the image data is lost when, for example, image processing on image data associated with audio data is performed and the newly generated image data is transmitted.

In addition, it is also not taken into account that not only association between the image and the audio data but also association between the image and the additional information such as protection and rating is also lost.

### SUMMARY

Some embodiments of the present disclosure were made in view of the aforementioned problems and provide an image processing apparatus that, in processing an image including associated data, can maintain the association between the associated data and the image after processing.

According to a first aspect of the present disclosure, there is provided an image processing apparatus that comprises at least one processor configured to perform processing on image data; determine whether or not the image data includes associated data that is data in association with the image data; and associate, when the image data includes the associated data, the associated data with image data after processing that is processed and generated in the processing.

According to a second aspect of the present disclosure, there is provided an image processing method that comprises processing image data; determining whether or not the image data includes associated data that is data in association with the image data; and associating, when the image data includes the associated data, the associated data with image data after processing that is processed and generated in the processing.

Further features of various embodiments will become apparent from the following description of exemplary embodiments with reference to the attached drawings.

### BRIEF DESCRIPTION OF THE DRAWINGS

FIG. 1 is a block diagram illustrating a configuration of a digital camera, which is an embodiment of an image processing apparatus of the present disclosure.

FIG. 2A to FIG. 2D are diagrams illustrating a procedure of transmitting an image to outside from the digital camera.

FIG. 3A to FIG. 3C are diagrams illustrating a procedure of adding audio data to image data.

FIG. 4 is a flowchart illustrating a procedure of performing image processing.

FIG. 5A to FIG. 5D are diagrams illustrating examples of screens displayed in the image processing.

### DESCRIPTION OF THE EMBODIMENTS

Hereinafter, embodiments will be described in detail with reference to the attached drawings. Note, the following embodiments are not intended to limit every embodiment. Multiple features are described in the embodiments, but limitation is not made to embodiments that require all such features, and multiple such features may be combined as appropriate. Furthermore, in the attached drawings, the same reference numerals are given to the same or similar configurations, and redundant description thereof is omitted.

Although an embodiment will be described in the following description in which an image processing apparatus of the present disclosure is applied to an image capturing apparatus, such as a digital camera, some embodiments are not limited thereto. The present disclosure can also be applied to an information processing apparatus such as, for example, a mobile phone, a portable media player, a so-called tablet device, and a personal computer.

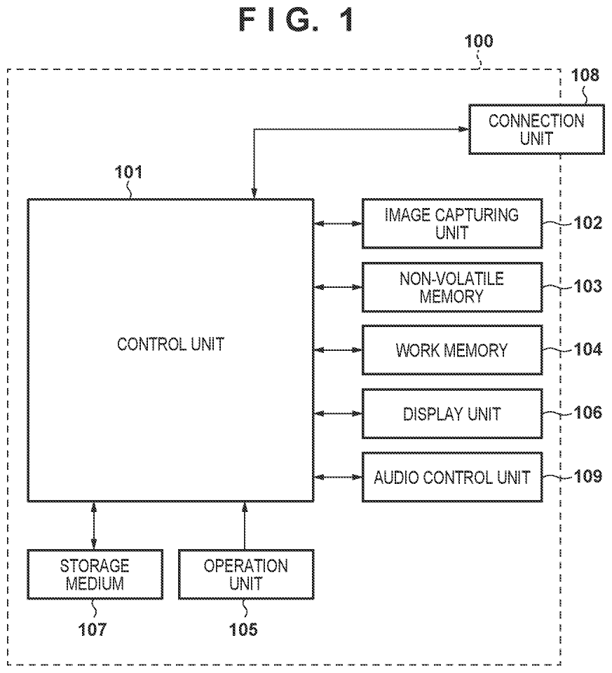

FIG. 1 is a block diagram illustrating a configuration of a digital camera 100, which is an embodiment of an image processing apparatus of the present disclosure.

In FIG. 1, a control unit 101 controls each unit of a digital camera 100 in accordance with input signals or programs. Here, instead of the control unit 101 that controls the entire digital camera, a plurality of hardware may control the entire digital camera by the plurality of hardware sharing the processing.

An image capturing unit 102 includes image capturing elements constituted by a CCD or a CMOS sensor and converts, into an image signal, light from a subject focused by a lens. The image signal being converted is further performed with processing, such as A/D conversion processing or noise reduction processing, and the signal being processed is output as image data. The image data obtained at the image capturing unit 102 is stored in a buffer memory and subsequently subjected to predetermined processing in the control unit 101 and stored in a storage medium 107.

A non-volatile memory 103, which is an electrically erasable and recordable non-volatile memory, stores a program or the like that is executed by the control unit 101.

A work memory 104 is used as a buffer memory that temporarily holds image data captured by the image capturing unit 102, an image display memory of a display unit 106, a work area of the control unit 101, or the like.

An operation unit 105 is used for accepting instructions from a user to the digital camera 100. The operation unit 105 includes an operation member such as, for example, a power button for the user to instruct ON/OFF of the power of the digital camera 100, a release switch configured to instruct capturing, and a playback button configured to instruct playback of image data. In addition, the operation unit 105 also includes a touch panel arranged at the display unit 106 described below. Here, the release switch includes a switch SW1 and a switch SW2. When the release switch is in a so-called half-pressed state, the switch SW1 is turned on. By this operation, instructions are received for making preparations for image capturing, such as auto focus (AF) processing, auto exposure (AE) processing, auto white balance (AWB) processing, flash preliminary emission (EF) processing, and the like. When the release switch is in a so-called full-pressed state, the switch SW2 is turned on. By this operation, instructions for capturing are received.

The display unit 106 performs display of a viewfinder image at a time of capturing, display of captured image data, display of characters used for an interactive operation screen, and the like. Note that the display unit 106 need not necessarily be built in the digital camera 100. It suffices that the digital camera 100 can be connected to the internal or external display unit 106, and has at least a display control function that controls display of the display unit 106.

The storage medium 107 can store image data output from the image capturing unit 102. The storage medium 107 may be configured to be attachable to and detachable from the digital camera 100, or may be built in the digital camera 100. In other words, it suffices that the digital camera 100 includes at least a unit configured to access the storage medium 107.

A connection unit 108 is a communication unit built in the main body of the digital camera 100. The control unit 101 realizes communication with the external apparatus by controlling the communication unit 108. The communication scheme is a wireless LAN, a wired LAN, or the like.

An audio control unit 109 converts audio signals from analog signals to digital data. The control unit 101 generates voice memo data based on an audio signal acquired by a microphone (not illustrated) and associates the voice memo data with the image data.

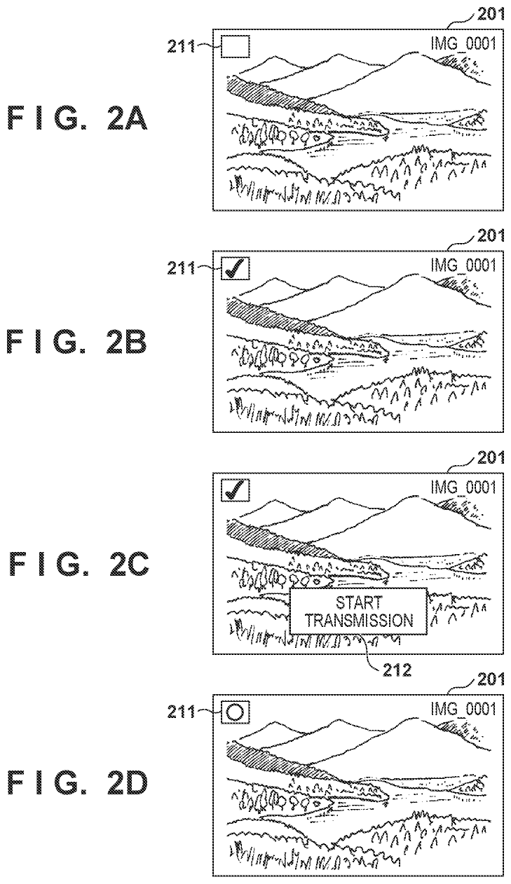

Next, a procedure of transmitting an image from the digital camera 100 to the outside according to the present embodiment will be described. FIG. 2A to FIG. 2D are diagrams illustrating a procedure of transmitting an image to the outside from the digital camera 100. Transmission of the image is performed as follows.

It is assumed that a plurality of images is stored in the storage medium 107. A menu is displayed on the display unit 106 by the user pressing a menu button included in the operation unit 105. The thumbnail images are displayed on the display unit 106 by the user selecting display of the thumbnail images from the displayed menu. Furthermore, the user can select a candidate for an image to be transmitted to the outside by selecting an image from the thumbnail images through touch panel operation or key operation in the operation unit 105.

In FIG. 2A, a state is illustrated in which an image 201 is selected as a candidate for the image to be transmitted to the outside and the image 201 is displayed on the full screen.

Here, the control unit 101 of the digital camera 100 manages a state of transmission relating to an image stored in the storage medium 107 in association with the image, such as whether the image is a transmission target or not, whether the image is already transmitted or not, whether the image is selected as a transmission target or not, and the like.

When, for example, the image 201 is selected as a candidate for the image to be transmitted to the outside, the control unit 101 displays the image 201 on the full screen of the display unit 106, as illustrated in FIG. 2A.

Then, when the user selects the image 201 as an image to be transmitted in the state of FIG. 2A by operation of a set button or the like in the operation unit 105, the control unit 101 manages the image 201 as being in a “waiting-for-transmission” state. In addition, the control unit 101 displays, for example, a check mark on a check box 211 indicating the waiting-for-transmission, as illustrated in FIG. 2B.

When the user further operates, in the state of FIG. 2B, the set button or the like in the operation unit 105, the image 201 is transmitted to the outside. When the transmission is completed, the control unit 101 manages the image 201 as being in an already transmitted state. In addition, a circle on the check box 211, for example, indicating completion of the transmission is displayed, as illustrated in FIG. 2D.

Further, when the user selects the image 201 as an image to be transmitted, a “start transmission” button may be displayed as illustrated in FIG. 2C, together with the display of the check mark on the check box 211. In such a case, the user can transmit the image 201 to the outside by pressing the “start transmission” button on the touch panel of the display unit 106.

Also, although the foregoing description explains that the image is transmitted by the user selecting the image 201 as an image to be transmitted and then performing a transmission operation, the image 201 may be transmitted triggered by operation of the user selecting the image 201 as an image to be transmitted.

Furthermore, although the foregoing description explains a method of selecting whether or not to transmit a single image displayed on the display unit 106, an option may be displayed as a menu such that a plurality of images can be selected at a time. As the transmission management method, information of “waiting-for-transmission”, “transmitted” and “not transmitted” may be managed for each image, for example, and the information may be held in the storage medium 107 as a hidden file. Also, the work memory 104 may be updated at every change in a transmission state. Also, information of the transmission state may be held inside the image file as meta information.

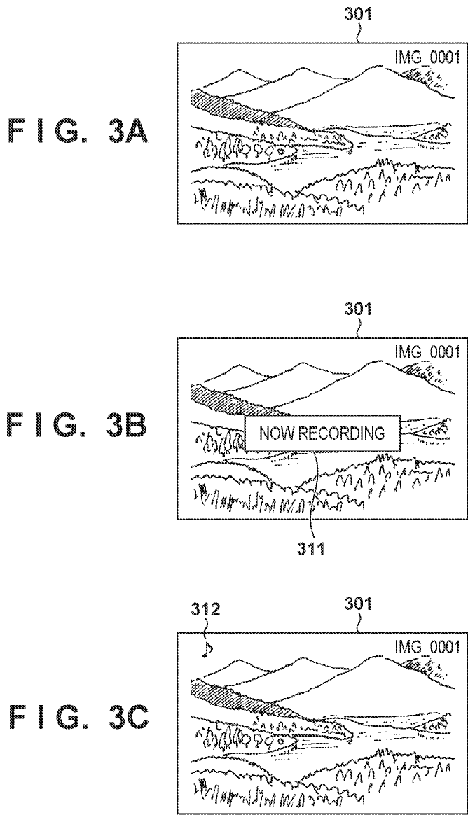

Next, a method of adding audio data to image data will be described. FIG. 3A to FIG. 3C are diagrams illustrating a procedure of adding audio data to the image data.

In FIG. 3A, a state is illustrated in which the image 301 in the storage media 107 is played back and displayed on the display unit 106 in the digital camera 100. In order to add audio data to the image 301 being played back, the operation unit 105 is operated to start recording of the audio data, for example. A display example is illustrated in FIG. 3B, indicating a state in which audio data is being recorded. As illustrated in FIG. 3B, a notification 311 “now recording” is displayed. The audio data is acquired using a microphone (not illustrated) and the audio control unit 109. The acquired audio signal is converted into digital audio data by A/D conversion, and subjected to signal processing by the control unit 101. The audio data subjected to audio processing is associated with target image data and stored in the storage medium 107. When an image that is added with audio data is displayed, a “J” mark 312 is displayed as illustrated in FIG. 3C to indicate the addition of the audio data.

Although the method of associating audio data with image data is not particularly limited, it is conceivable, for example, to employ a similar file name for the audio data with that of the image data, and perform a processing for storing the audio data in a file with a different extension. In such a case, audio data associated with “IMG-0001.jpg”, for example, is stored with a file name “IMG-0001.wav”.

As another method, a method is conceivable in which information of the generated audio data file such as, for example, an identifier that uniquely identifies the audio data file, is described in the header information part of the image data. In the present embodiment, a case is described in which audio data is stored as a separate file, however audio data may be embedded in a part of image data.

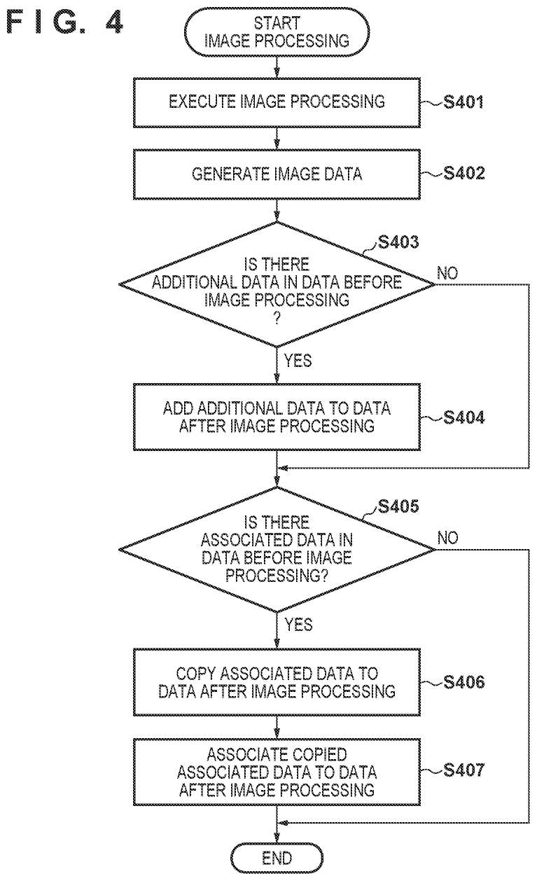

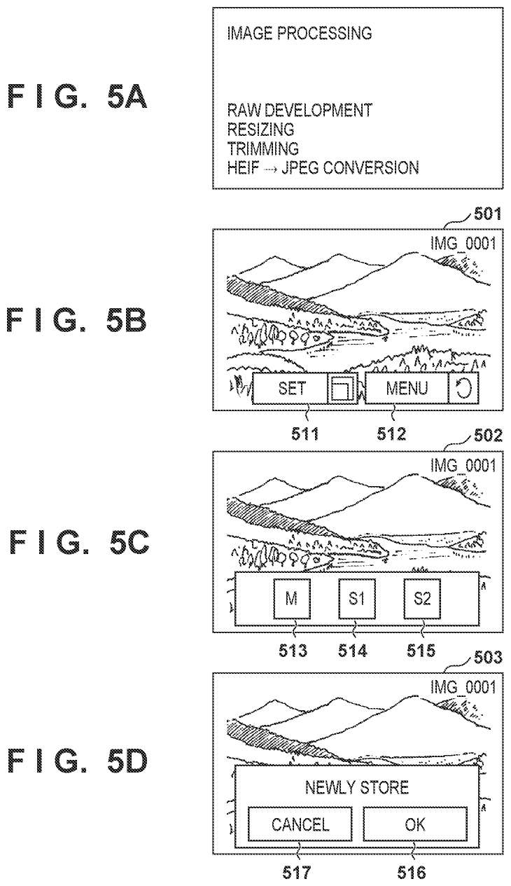

Next, an operation of performing image processing on an image having additional data or associated data will be described. FIG. 4 is a flowchart illustrating a procedure of performing image processing, and FIG. 5A to FIG. 5D are diagrams illustrating a display screen midway through the image processing. The operation of the flowchart of FIG. 4 is realized by the control unit 101 executing a program stored in the non-volatile memory 103.

In FIG. 4, the control unit 101 starts image processing, at step S401, based on an instruction to start image processing by the user operating the operation unit 105.

FIG. 5A to FIG. 5D are diagrams illustrating examples of screens displayed on the display unit 106 in the image processing. In a step before execution of step S401, a menu screen such as that illustrated in FIG. 5A is displayed on the display unit 106. By operating the operation unit 105, the user can select an image processing to be performed from the menu screen of FIG. 5A. The image processing may be conceivable to be, for example, RAW development processing, resizing processing, trimming processing, JPEG conversion processing, or the like. Here, it is assumed that resizing processing is selected.

When resizing processing is selected, the control unit 101 displays an image 501 to be subjected to image processing, as illustrated in FIG. 5B. In addition, a SET button 511, a MENU button 512 and the like are displayed on the screen. The user can decide an image to be subjected to image processing by pressing the SET button 511 via the touch panel, for example. In addition, the user can return to the menu screen of image processing items on the previous screen by pressing the MENU button 512.

In response to the SET button 511 being pressed, the control unit 101 displays a screen 502 on the display unit 106 for selecting a size for resizing, as illustrated in FIG. 5C. In the screen 502 configured for selecting a size, an M-size button 513, an S1-size button 514, and an S2-size button 515 are displayed, for example, as buttons for selecting a size. The user can select, by these buttons, an image size after processing in performing resizing.

When any one of the M-size button 513, the S1-size button 514, and the S2-size button 515 is pressed, the control unit 101 displays an image processing execution screen 503 on the display unit 106, as illustrated in FIG. 5D. In the image processing execution screen 503, there is an OK button 516 and a cancel button 517 for selecting whether or not to newly store the image after image processing. The user selects the cancel button 517 when the user does not newly store the image subjected to image processing, or selects the OK button 516 when the user newly stores the image after image processing. When the OK button 516 is selected in the image processing execution screen 503, the control unit 101 starts image processing, at step S401, on the selected image.

At step S402, the control unit 101 newly generates image data (image data after processing) as a result of executing the image processing at step S401, and stores the image data in the storage media 107.

At step S403, the control unit 101 determines whether or not there is additional data in the image before being subjected to the image processing at step S401. The control unit 101 advances the processing to step S404 when there is additional data, or advances the processing to step S405 when there is no additional data.

At step S404, the control unit 101 adds the additional data to the image data generated at step S402. It is conceivable that the additional data may include, for example, protection information or rating information.

Here, a method of using the image protection information will be described. It goes without saying that the protection information is information for protecting an image from browsing or modification. However, besides such an ordinary usage, the protection information may be provided by the user for the purpose of marking an image of interest when the user selects a target image from a large number of images. In a case where the user performs image processing on an image of interest, if the protection information in the image subjected to image processing is lost, there is a possibility that the user cannot find the image of interest which is selected by the user. It is therefore important to preserve the protection information before and after image processing.

It is conceivable that Exif information is copied and inherited in general before and after image processing. However, since the protection information is stored in the file system (FAT region) instead of in the Exif, the protection information cannot be copied by simply copying the Exif information. The present embodiment therefore inherits not only the Exif but also the protection information before and after image processing. In addition, since there is also a possibility that the rating information is not inherited before and after image processing, the rating information is also added again to the image data after image processing.

Here, the contents of the Exif information which can be inherited before and after image processing is inherited. In a case of image processing of resizing, for example, a resolution is altered and thus an item of the resolution is not inherited, but other pieces of inheritable information are inherited. Similar pieces of information with respect to protection and rating are added to the image after image processing.

At step S405, the control unit 101 determines whether or not there exists any associated data in an image before being subjected to image processing at step S401. The control unit 101 advances the processing to step S406 when there exists associated data, or the control unit 101 terminates the processing when there is no associated data.

At step S406, the control unit 101 copies the associated data associated with the image before being subjected to image processing at step S401, and temporarily holds the associated data in the work memory 104.

Although the associated data may be assumed to be audio data, for example, other associated data besides audio data may also be used. In the present embodiment, the aforementioned additional data and the associated data may be collectively referred to as associated data that is data in association with an image.

At step S407, the control unit 101 associates the associated data, which is temporarily held in the work memory 104 at step S406, with the image data generated at step S402 and stores the associated data in the storage media 107. When the foregoing processing is completed, the processing of the flowchart is terminated.

According to the present embodiment, as has been described above, when image processing is performed on the image data having the additional data or having the existing associated data, the processing of associating the additional data or the associated data with newly generated image data after image processing is performed. Accordingly, the association of the additional data or the associated data with the newly generated image data after image processing is maintained. As a result, in a case where transmission management is performed by selecting an image using the additional data or the associated data, the additional data and the associated data are inherited after image processing, whereby user convenience can be improved.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-050388, which was filed on Mar. 27, 2023 and which is hereby incorporated by reference herein in its entirety.

What is claimed is:

1. An image processing apparatus comprising at least one processor configured to:
perform processing on image data;
determine whether or not the image data includes associated data that is data in association with the image data; and
associate, when the image data includes the associated data, the associated data with image data after processing that is processed and generated in the processing.

2. The image processing apparatus according to claim 1, wherein the at least one processor is further configured to acquire the image data by capturing an image of a subject.

3. The image processing apparatus according to claim 2, wherein the at least one processor is further configured to acquire the associated data.

4. The image processing apparatus according to claim 3, wherein the at least one processor is further configured to store the image data in association with the associated data.

5. The image processing apparatus according to claim 1, wherein the at least one processor is further configured to transmit the image data to another apparatus.

6. The image processing apparatus according to claim 5, wherein the at least one processor is further configured to manage a transmission state of the image data to the other apparatus.

7. The image processing apparatus according to claim 1, wherein the processing is trimming processing or resizing processing.

8. The image processing apparatus according to claim 1, wherein the associated data is protection information or rating information.

9. The image processing apparatus according to claim 1, wherein the associated data is audio data.

10. An image processing method comprising:
processing image data;
determining whether or not the image data includes associated data that is data in association with the image data; and
associating, when the image data includes the associated data, the associated data with image data after processing that is processed and generated in the processing.

11. A non-transitory computer-readable storage medium storing computer-executable instructions for causing a computer to execute an image processing method, the image processing method comprising:
processing image data;
determining whether or not the image data includes associated data that is data in association with the image data; and
associating, when the image data includes the associated data, the associated data with image data after processing that is processed and generated in the processing.
